(19) United States
(12) Patent Application Publication
(10) Pub. No.: US 2016/0352821 A1
(43) Pub. Date: Dec. 1, 2016

(54) METHOD AND SYSTEM FOR ALLOCATING RESOURCES FOR VIRTUAL HOSTS

(71) Applicant: Alibaba Group Holding Limited, George Town (KY)

(72) Inventor: Shaohua Zhu, Hangzhou (CN)

(73) Assignee: Alibaba Group Holding Limited, George Town (KY)

(21) Appl. No.: 15/159,680

(22) Filed: May 19, 2016

(30) Foreign Application Priority Data
May 26, 2015 (CN) 201510275542.4

(51) Int. Cl. H04L 29/08

(52) U.S. Cl. CPC H04L 67/1008; H04L 67/10

(57) ABSTRACT

Embodiments of the present application provide a method and system for allocating resources for a virtual host. During operation, the system may receive a request to generate the virtual host. The system may assign a server to the virtual host based on the request. The available resources on the assigned server satisfy resource requirements of the virtual host. The available resources of the assigned server and the resource requirements of the virtual host are measured using a same resource unit. The system may then allocate resources required by the virtual host on the assigned server.

### RELATED APPLICATION

Under 35 U.S.C. 119, this application claims the benefits and rights of priority of Chinese Patent Application No. 201510275542.4, filed 26 May 2015.

### BACKGROUND

Field

The present invention relates to communication technology, and particularly relates to a method and system for allocating resources for virtual hosts.

Related Art

With current technology, multiple cloud virtual hosts may share the resources of the same server. Cloud virtual hosts can be categorized into different models depending on the amount of resources to be allocated to a cloud virtual host. When resources are allocated, since the virtual hosts on the same server share the server resources, an overload of the server will slow down all cloud virtual hosts on the server. Accordingly, in order to facilitate load management of a server, only virtual hosts of the same model reside on one server, which allows for estimating the number of cloud virtual hosts that can reside on the server. According to this approach for allocating resources, cloud virtual hosts of different models cannot reside on the same server.

However, with an increase in new users, new models of cloud virtual hosts are continuously emerging. New models are emerging according to the needs of the market and newer models with advanced configurations are emerging with decreasing information technology (IT) costs. Due to the above two reasons, new models are being introduced, and old models are no longer being sold and taken offline. While each model of cloud virtual host corresponds to at least one server which is running the cloud virtual host, with the discontinued sale of old cloud virtual hosts, as some of the cloud virtual hosts expire, the load of the server becomes lower and a great amount of resources is wasted.

Therefore, at the present time there is a urgent need to decrease the waste of resources on a server.

### SUMMARY

One embodiment of the present invention provides a system for allocating resources. During operation, the system may receive a request to generate a virtual host. The system may assign a server to the virtual host based on the request, with available resources on the assigned server satisfying resource requirements of the virtual host. The available resources of the assigned server and the resource requirements of the virtual host can be measured using a same resource unit. The system may then allocate resources required by the virtual host on the assigned server.

In a variation of this embodiment, the request includes information indicating the resource requirements of the virtual host, and the resources required by the virtual host are measured using the resource unit.

In a variation of this embodiment, the request includes information indicating a model of the virtual host.

In a further variation, assigning a server to the virtual host based on the request includes determining resource requirements of the virtual host according to a predetermined corresponding relationship between a predetermined model and a respective amount of resources required, and according to the model of the virtual host, in which the amount of resources is measured using the resource unit. The system may then search for an assigned server with available resources greater than or equal to the resources required by the virtual host, in which the available resources of the assigned server is measured using the resource unit.

In a variation on this embodiment, the system may update data indicating the available resources on the assigned server.

In a variation on this embodiment, the resource unit includes a computing unit of measure for measuring a computing resource and a storage unit of measure for measuring a storage resource.

In a further variation, the computing unit of measure is 128 MB of memory and one-sixteenth core CPU, and the storage unit of measure is 1.6 GB of storage space.

### BRIEF DESCRIPTION OF THE DRAWINGS

The accompanying drawings described herein are used for further understanding the present application and constitute a part of the present application, and the schematic embodiments of the present application and the descriptions thereof are used for interpreting the present application, rather than improperly limiting the present application. In which:

FIG. 1 presents a diagram illustrating an exemplary computing system for allocating resources, in accordance with an embodiment of the present invention.

FIG. 2 presents a flowchart illustrating an exemplary process for allocating resources, in accordance with an embodiment of the present invention.

FIG. 3 presents a flowchart illustrating sub-operations for determining resource requirements of a virtual host and searching for a server with available resources, in accordance with an embodiment of the present invention.

FIG. 4 presents a flowchart illustrating another exemplary process for allocating resources, in accordance with an embodiment of the present invention.

FIG. 5 is a block diagram illustrating an exemplary apparatus for allocating resources, in accordance with an embodiment of the present invention.

FIG. 6 is a schematic diagram illustrating an exemplary assigning module, in accordance with an embodiment of the present invention.

FIG. 7 is a block diagram illustrating another exemplary apparatus for allocating resources, in accordance with an embodiment of the present invention.

FIG. 8 presents a block diagram illustrating an exemplary server in a system for allocating resources for virtual hosts, in accordance with an embodiment of the present application.

### DETAILED DESCRIPTION OF EMBODIMENTS

Embodiments of the present invention solve the problem of decreasing resource waste on servers by using a same unit of measure to measure server resources and resource requirements of different models of virtual hosts. This allows a resource allocation system to assign different models of virtual hosts to the same server. A virtual host can be, for example, a provider of Web services that includes server functions and Internet connection services. A Web server can run multiple virtual hosts for multiple websites, with each virtual host including a separate domain and customized settings for each website. In some embodiments, the techniques described herein can also apply to allocating resources for guest virtual machines that reside on a virtual machine host server and share the server's computing resources. The system can distribute guest virtual machines among multiple servers to better distribute the computing demands of the guest virtual machines. Note that one can apply the techniques described herein to any scenario involving allocating resources among multiple servers.

The system can allocate server resources more efficiently to different models of virtual hosts that may have different resource requirements. The system can assign a virtual host to a server that has the available resources to satisfy the resource requirements of the virtual host, regardless of the model of the virtual host. When the virtual host expires, the system can re-allocate the server resources to one or more new virtual hosts. With the techniques described herein, the system is no longer limited to requiring only virtual hosts of the same model reside on a server, and the system can more efficiently allocate and reuse resources on servers.

Exemplary Computing System For Allocating Resources

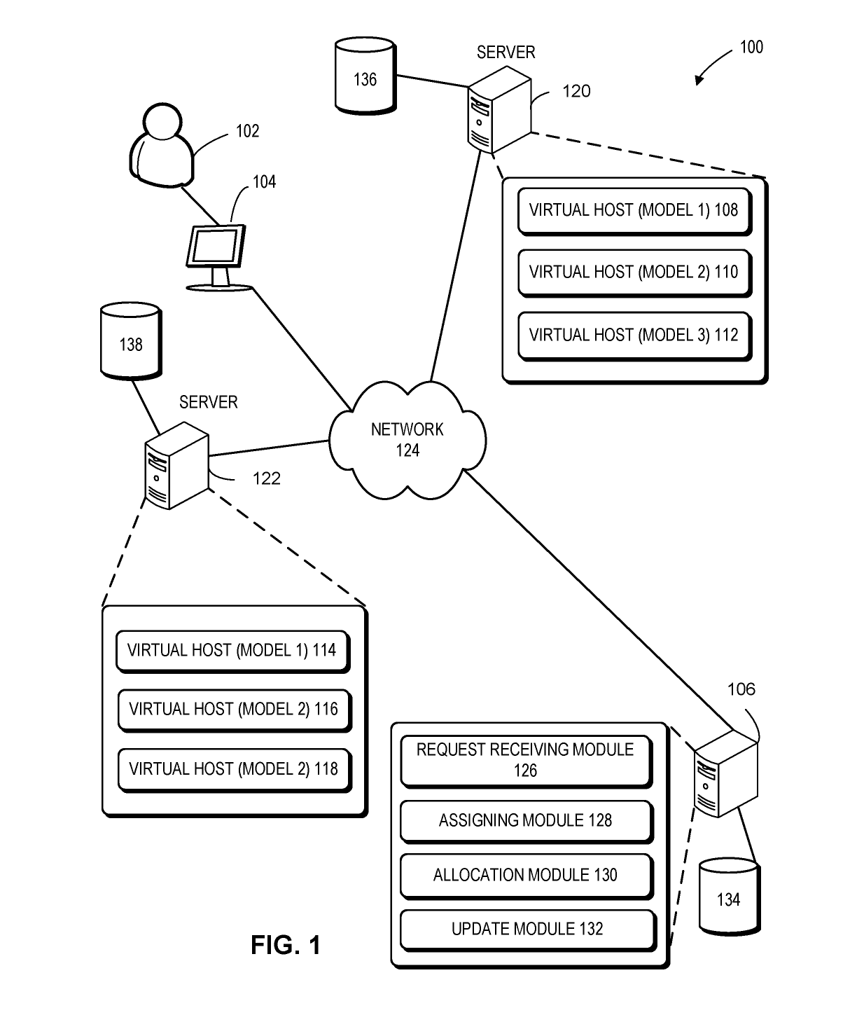

FIG. 1 presents a diagram illustrating an exemplary computing system 100 for allocating resources, in accordance with an embodiment of the present invention. As illustrated in FIG. 1, a user 102 may be operating a computing device 104 with installed modules that allows user 102 to access a device 106 managing virtual hosts 108-118 running on servers 120, 122. Although FIG. 1 depicts a separate device managing virtual hosts running on multiple different servers, the device or functionality associated with the device may also be integrated into the servers running the virtual hosts. Computing device 104 may be a desktop computer or a mobile device such as a mobile phone, a tablet, or a laptop, or any other type of computing device. Computing device 104 may communicate with device 106 over a network 124. Device 106 may be a computing device executing various modules for allocating resources, such as a request receiving module 126, an assigning module 128, an allocation module 130, and an update module 132.

Request receiving module 126 may receive a request for generating a virtual host. Assigning module 128 may assign a server to the virtual host based on the request, with the available resources on the assigned server satisfying the resource requirements of the virtual host. Allocation module 130 may allocate the resources required by the virtual host on the assigned server. Update module 132 may update data indicating the available resources on the assigned server. Device 106 may also include a storage 134 for storing code for the modules described herein, such as the request receiving module or assigning module.

Server 120 may represent a server running multiple instances of virtual hosts, such as virtual host (model 1) 108, virtual host (model 2) 110, and virtual host (model 3) 112. Server 122 may represent a server running multiple instances of virtual hosts, such as virtual host (model 1) 114, virtual host (model 2) 116, and virtual host (model 2) 118. Servers 120, 122 may each include a respective storage 136, 138 for storing code for the virtual hosts, various applications, and other data.

### Exemplary Process For Allocating Resources

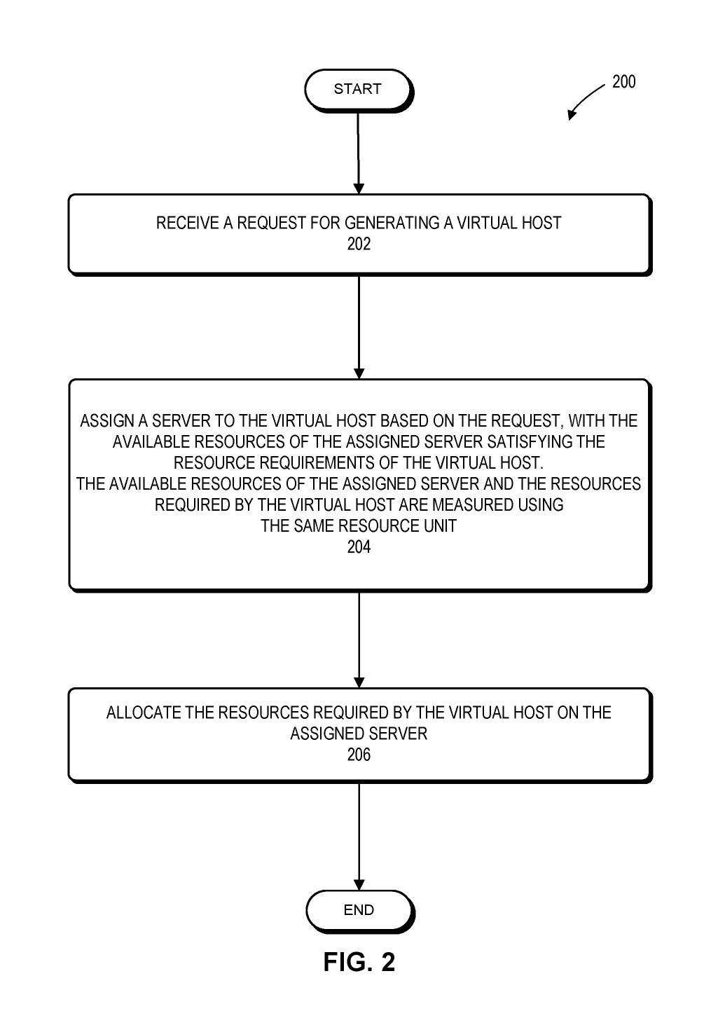

FIG. 2 presents a flowchart illustrating an exemplary process 200 for allocating resources, in accordance with an embodiment of the present invention. During operation, the system may initially receive a request for generating a virtual host (operation 202). A device for allocating resources (hereafter referred to as “the device”) may be a device separate and independent from each server which is in communication with each server. In some embodiments, the device or functionality associated with the device may also be provided in each server.

When the device allocates resources, the device may first receive from another device or system a request for generating a virtual host which may indicate a model of the virtual host, with different models having different resource requirements. The request may also include data indicating the resource requirements of the virtual host, such as the required amount of memory, number of CPU cores, and the amount of storage space. The virtual host may be a cloud virtual host.

The system may then assign a server to the virtual host based on the request, with the available resources of the assigned server satisfying the resource requirements of the virtual host (operation 204). The available resources of the assigned server and the resources required by the virtual host are measured using the same resource unit.

In an embodiment, the resources of each server are not divided according to the resource requirements of a single virtual host of a particular model. Instead, the system pre-measures the resource requirements of different models of virtual hosts and the resources of the server using the same resource unit. In this way, the system can allocate server resources in accordance with the number of resource units required by a virtual host, and the system need not consider the model of the virtual host.

Upon receiving the request, the device starts to search in sequence for a suitable server from a plurality of servers to allocate resources. In particular, the device may look up the servers one by one in a predetermined sequence, and when the device finds a server with available resources satisfying the resource requirements of the virtual host, the device determines that the server is the assigned server. When there is no server with available resources that satisfies the resource requirements of the virtual host, the system may enable a new server for use as the assigned server.

When the device looks up a server, the device may obtain data indicating the available resources of the server, or the server may report to the device the available resources of the server on its own initiative.

The system may then allocate the resources required by the virtual host on the assigned sever (operation 206). As soon as the device determines which server to assign to the virtual host, the system can allocate the resources required by the virtual host to the virtual host on the assigned server.

The system may use the same resource unit to measure the resources of the server and the resources required by the virtual host so that when the system allocates the resources of the server, the system need not consider the model of the virtual host. The system can allocate the resources of the server based only on the resources required by the virtual host, thereby allowing different models of virtual hosts to share the resources of the same server. This method can make the best use of server resources, as when some virtual hosts on the server expire and are no longer in service, the system can re-allocate the available resources on the server to other different virtual host models or to newly added virtual hosts, thereby decreasing waste of server resources.

### Determining Resource Requirements of a Virtual Host and Searching for a Server With Available Resources

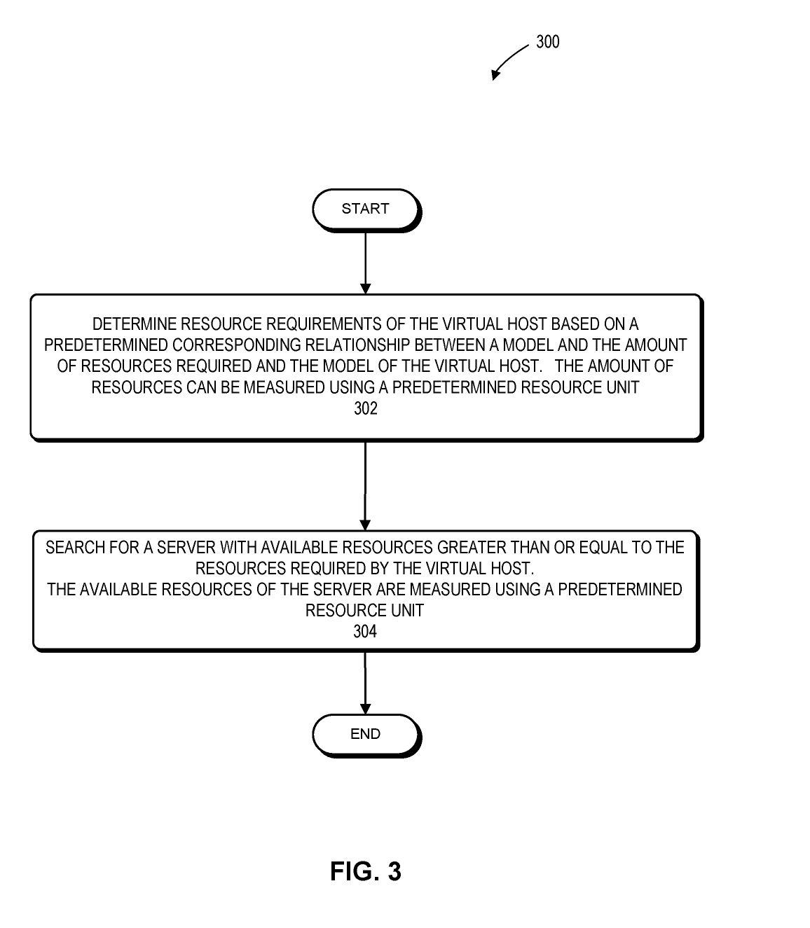

FIG. 3 presents a flowchart 300 illustrating exemplary sub-operations for determining resource requirements of a virtual host and searching for a server with available resources, in accordance with an embodiment of the present invention. In some embodiments, the system (e.g., device) may receive a request for generating a virtual host that may directly include information about the resource requirements of the virtual host, and the system may predetermine resource requirements for the virtual host. The resource requirements may be premeasured using the resource unit described above. Alternatively, the device may receive a request for generating a virtual host that may include information about the model of the virtual host, and then, as shown in FIG. 3, assigning, by the device, a server to the virtual host based on the request may include the following operations:

The system may determine the resource requirements of the virtual host based on a predetermined corresponding relationship between the model and the amount of resources required and the model of the virtual host (operation 302). The amount of resource can be measured using a predetermined resource unit.

The predetermined resource unit may include multiple units of measure, such as a computing unit of measure for measuring computing resources and a storage unit of measure for measuring storage resources. For example, considering a cloud server equipped with a 4-core central processing unit (CPU), 8 gigabytes (GB) memory and 100 GB storage disk, which is normalized to be 64 (sixty-four) computing units and 64 storage units, then each of the computing unit of measure can be 128 megabytes (MB) of memory and one-sixteenth core central processing unit (CPU), and the storage unit of measure can be 1.6 gigabytes GB storage space.

As an example, the corresponding relationships between the model of a cloud virtual host and the amount of resources required may be as indicated in the table below:

| | Number of Computing | |
|---|---|---|
| Model | Units | Number of Storage Units |
| Model 1 | 1 unit | 1 unit |
| Model 2 | 2 units | 2 units |
| Model 3 | 3 units | 3 units |

In this operation, the device first uses the model information of the virtual host included in the request to look up the required resources for the virtual host in the corresponding relationship table. For example, if the model of the virtual host is 3, then the resources required is 3 units for the computing resource, and 3 units for the storage resource.

The system may search for a server with available resources greater than or equal to the resources required by the virtual host (operation 304). The available resources of the server is measured using a predetermined resource unit.

The number of computing units available on the server found by the device should be greater than or equal to the number of computing units required by the virtual host. Also, the number of storage units available on the server should be greater than or equal to the number of storage units required by the virtual host. For example, the number of computing units available on the server should be greater than or equal to three computing units, and the number of storage units available should be greater than or equal to three storage units.

### Exemplary Process For Allocating Resources

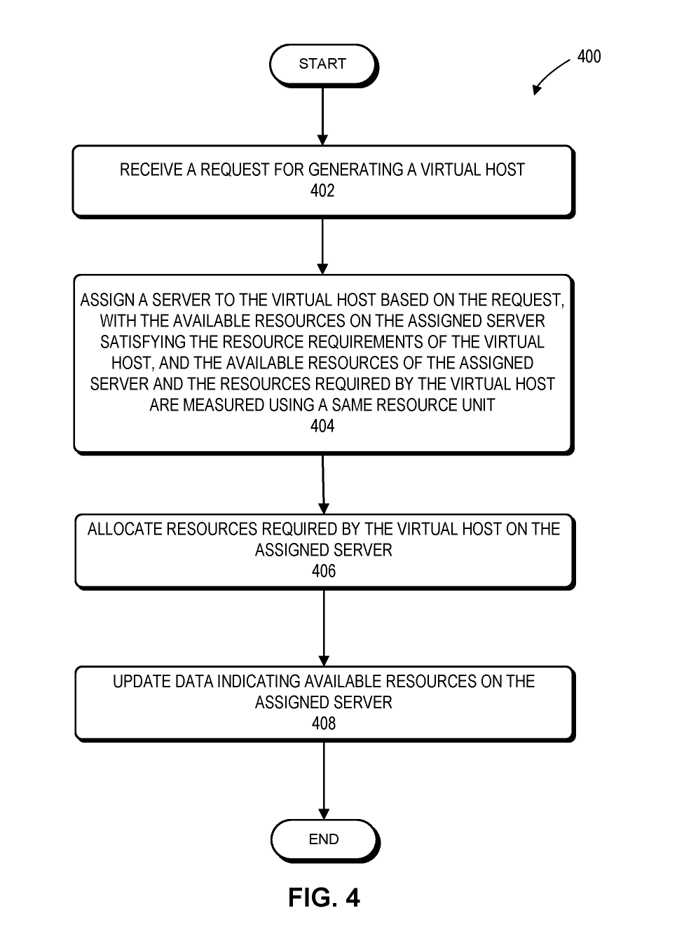

FIG. 4 presents a flowchart illustrating another exemplary process 400 for allocating resources, in accordance with an embodiment of the present invention. During operation, the system may initially receive a request for generating a virtual host (operation 402). The system may assign a server to the virtual host based on the request, with the available resources on the assigned server satisfying the resource requirements of the virtual host (operation 404). The available resources of the assigned server and the resources required by the virtual host are measured using a same resource unit. The system may allocate the resources required by the virtual host on the assigned server (operation 406). Note that operations 402-406 are similar to operations 202-206 of FIG. 2. After the system (e.g., device) allocates the resources required by the virtual host on the assigned server, the system may update data indicating available resources on the assigned server (operation 408).

The system (e.g., device) may deduct the resources that have been allocated to the virtual host from the available resources of the assigned server, so that the system may allocate resources to another virtual machine based on the updated available resource information. In particular, the system may deduct the allocated computing resources and the allocated storage resources from the available resources.

Note that depending on implementation the operations of FIG. 4 can be performed in a different sequence or at the same time, and may also include additional operations or less operations.

### Exemplary Apparatus For Allocating Resources

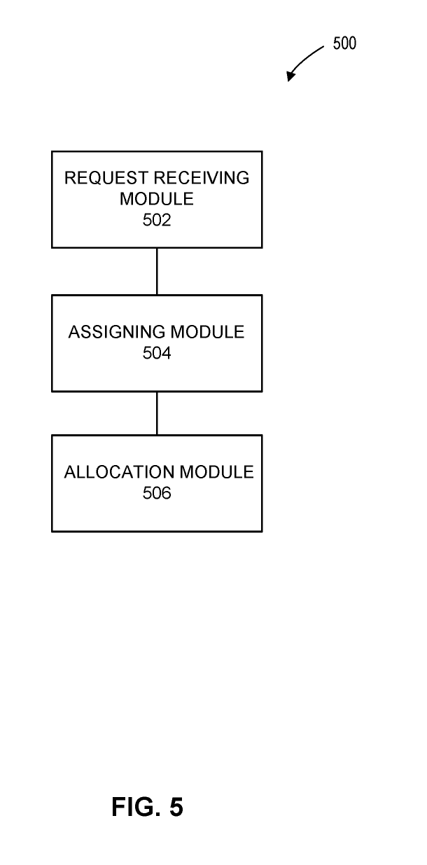

FIG. 5 is a block diagram illustrating an exemplary apparatus 500 for allocating resources, in accordance with an embodiment of the present invention. The apparatus may include a request receiving module 502, an assigning module 504, and an allocation module 506.

Request receiving module 502 may be configured to receive a request for generating a virtual host. Assigning module 504 may be configured to assign a server to the virtual host based on the request, with the available resources on the assigned server satisfying the resource requirements of the virtual host. The available resources of the assigned server and the resources required by the virtual host are measured with the same resource unit.

Allocation module 506 may be configured to allocate the resources required by the virtual host on the assigned server. The system may use the same resource unit to measure the resources of the server and the resources required by the virtual host so that the system need not consider the model of the virtual host when the system allocates the resources of the server. The system can allocate the resources of the server depending only on the resources required by the virtual host, thereby allowing different models of virtual hosts to share the resources of the same server. This apparatus can make the best use of the resources on the server, as when some virtual hosts on the server expire and are out of service, the available resources on the server can be allocated to other hosts of different models or to newly added virtual hosts, thereby decreasing the waste of resources on the server.

In some embodiments, the request received by the request receiving module 502 may include information about the resource requirements of the virtual host, and the amount of resources required by the virtual host is premeasured using the resource units as described above. In some embodiments, the request received by the request receiving module 401 may include information about the model of the virtual host.

### Exemplary Assigning Module

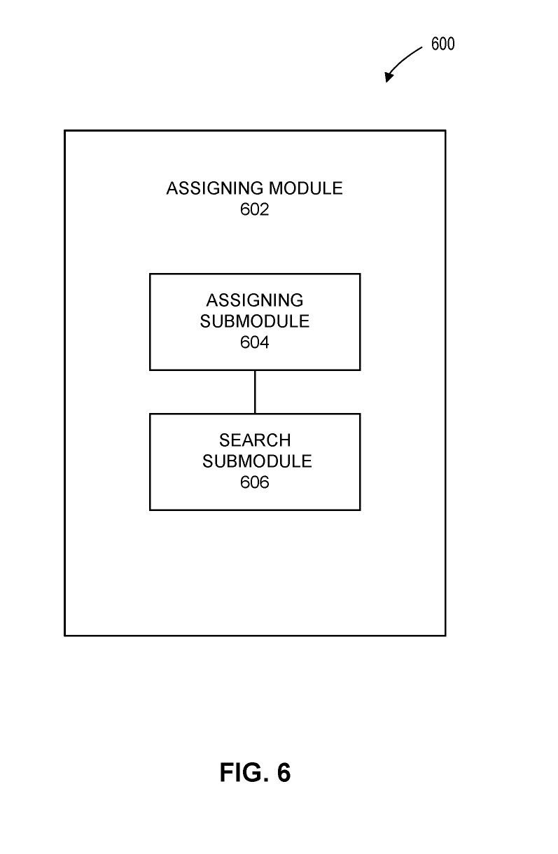

FIG. 6 is a schematic diagram 600 illustrating an exemplary assigning module 602, in accordance with an embodiment of the present invention. As shown in FIG. 6, assigning module 602 (which is equivalent to assigning module 504) may include submodules as described below.

An assigning submodule 604 can be configured to determine the resource requirements of the virtual host according to a predetermined corresponding relationship between a model and an amount of resources required, and the model of the virtual host.

The amount of resources is measured using a unit of measure called the resource unit.

A search submodule 606 can be configured to search for an assigned server having available resources greater than or equal to the resources required by the virtual host. The available resources of the assigned server is measured using the resource unit.

### Exemplary Apparatus For Allocating Resources

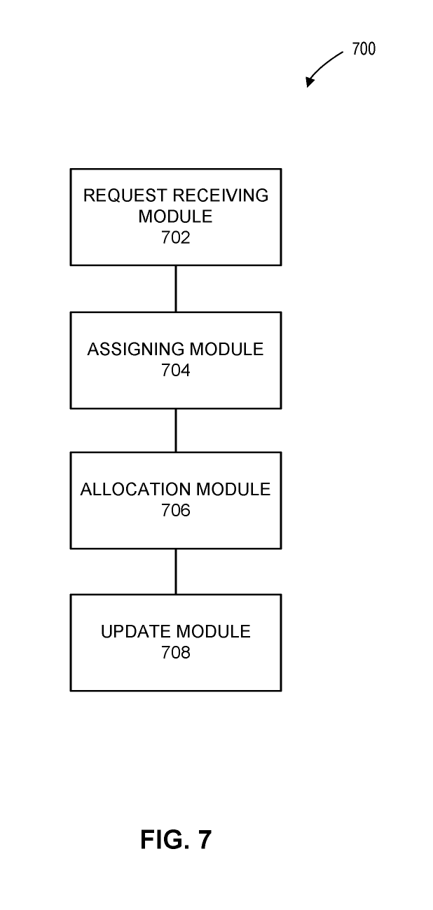

FIG. 7 is a block diagram illustrating another exemplary apparatus 700 for allocating resources, in accordance with an embodiment of the present invention. The apparatus of FIG. 7 may include a request receiving module 702, an assigning module 704, an allocation module 706, and an update module 708. Modules 702-706 are equivalent to modules 502-506 in FIG. 5. As shown in FIG. 7, the apparatus of FIG. 7 may further include an update module 708 configured to update data indicating the available resources on the assigned server.

The resource unit of measure may include a computing unit of measure for measuring a computing resource and a storage unit of measure for measuring a storage resource. For example, the computing unit of measure can be 128 MB of memory and one-sixteenth core CPU, and the storage unit of measure can be 1.6 GB storage space.

### Exemplary Server

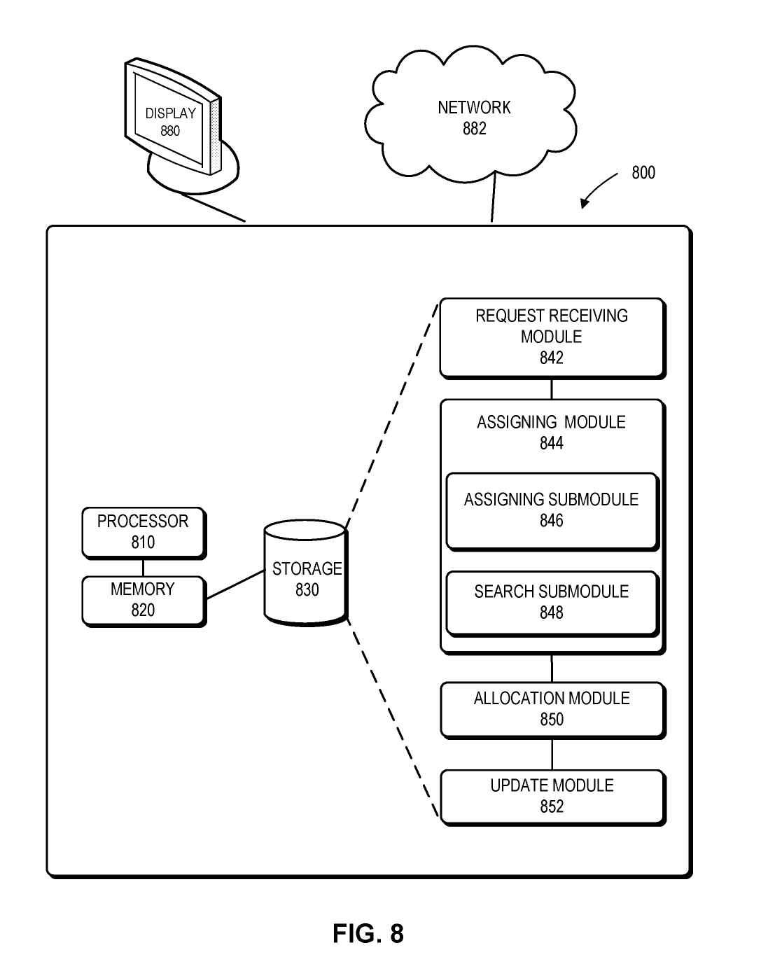

FIG. 8 presents a block diagram illustrating an exemplary server 800 in a system for allocating resources for virtual hosts, in accordance with an embodiment of the present application. Server 800 includes a processor 810, a memory 820, and a storage device 830. Storage 830 typically stores instructions that can be loaded into memory 820 and executed by processor 810 to perform the methods described above. In one embodiment, the instructions in storage 830 can implement a request receiving module 842, an assigning module 844, an assigning submodule 846, a search submodule 848, an allocation module 850, and an update module 852, which can communicate with each other through various means.

In some embodiments, modules 842-852 can be partially or entirely implemented in hardware and can be part of processor 810. Further, in some embodiments, the server may not include a separate processor and memory. Instead, in addition to performing their specific tasks, modules 842-852, either separately or in concert, may be part of special-purpose computation engines.

Storage 830 stores programs to be executed by processor 810. Specifically, storage 830 stores a program that implements a server (e.g., application) for allocating resources. During operation, the application program can be loaded from storage 830 into memory 820 and executed by processor 810. As a result, server 800 can perform the functions described above. Server 800 can further include an optional display 880, and can be coupled via one or more network interfaces to a network 882.

Request receiving module 842 may receive a request for generating a virtual host. Assigning module 844 may assign a server to the virtual host based on the request, with the available resources on the assigned server satisfying the resource requirements of the virtual host. Assigning submodule 846 may determine the resource requirements of the virtual host according to predetermined corresponding relationships between each predetermined model and a respective amount of resources required, and the model of the virtual host. Search submodule 848 may search for an assigned server having available resources greater than or equal to the resources required by the virtual host. Allocation module 850 may allocate the resources required by the virtual host on the assigned server. Update module 852 may update data indicating the available resources on the assigned server.

Embodiments of the present invention may be implemented on various universal or dedicated computer system environments or configurations. For example, such computer systems may include personal computers, server computers, handheld or portable devices, tablet-type devices, multiprocessor systems, microprocessor-based systems, set-top boxes, programmable electronic consumption devices, network PCs, minicomputers, mainframe computers, distributed computing environments including any of the above systems or devices, and the like.

Embodiments of the present invention may be described within the general context of computer-executable instructions executed by a computer, such as a program module. Generally, the program module includes a routine, a program, an object, an assembly, a data structure and the like for implementing particular tasks or achieving particular abstract data types. Embodiments of the present invention may also be implemented in distributed computing environments, in which tasks are performed by remote processing devices connected via a communication network. In the distributed computing environments, program modules may be located in local and remote computer storage media that may include a storage device.

The data structures and computer instructions described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

The above description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

What is claimed is:

1. A computer-implemented method for allocating resources, comprising:
receiving a request to generate a virtual host;
assigning a server to the virtual host based on the request, with available resources on the assigned server satisfying resource requirements of the virtual host, wherein the available resources of the assigned server and the resource requirements of the virtual host are measured using a same resource unit; and
allocating resources required by the virtual host on the assigned server.

2. The method of claim 1, wherein the request includes information indicating the resource requirements of the virtual host, and the resources required by the virtual host are measured using the resource unit.

3. The method of claim 1, wherein the request includes information indicating a model of the virtual host.

4. The method of claim 3, wherein assigning a server to the virtual host based on the request comprises:
determining resource requirements of the virtual host according to a predetermined corresponding relationship between a predetermined model and a respective amount of resources required, and according to the model of the virtual host, wherein the amount of resources is measured using the resource unit; and
searching for an assigned server with available resources greater than or equal to the resources required by the virtual host, wherein the available resources of the assigned server is measured using the resource unit.

5. The method of claim 1, further comprising:
updating data indicating the available resources on the assigned server.

6. The method of claim 1, wherein the resource unit includes a computing unit of measure for measuring a computing resource and a storage unit of measure for measuring a storage resource.

7. The method of claim 6, wherein the computing unit of measure is 128 MB of memory and one-sixteenth core CPU, and the storage unit of measure is 1.6 GB of storage space.

8. A computing system comprising:
a non-transitory computer-readable medium storing instructions stored;
one or more processors, coupled to the non-transitory computer-readable medium, and in response to the instructions stored on the non-transitory computer-readable medium, to perform:
receiving a request to generate a virtual host;
assigning a server to the virtual host based on the request, with available resources on the assigned server satisfying resource requirements of the virtual host, wherein the available resources of the assigned server and the resource requirements of the virtual host are measured using a same resource unit; and
allocating resources required by the virtual host on the assigned server.

9. The system of claim 8, wherein the request includes information indicating the resource requirements of the virtual host, and the resources required by the virtual host are measured using the resource unit.

10. The system of claim 8, wherein the request includes information indicating a model of the virtual host.

11. The system of claim 10, wherein assigning a server to the virtual host based on the request comprises:
determining resource requirements of the virtual host according to a predetermined corresponding relationship between a predetermined model and a respective amount of resources required, and according to the model of the virtual host, wherein the amount of resources is measured using the resource unit; and
searching for an assigned server with available resources greater than or equal to the resources required by the virtual host, wherein the available resources of the assigned server is measured using the resource unit.

12. The system of claim 8, the one or more processors further to perform:
updating data indicating the available resources on the assigned server.

13. The system of claim 8, wherein the resource unit includes a computing unit of measure for measuring a computing resource and a storage unit of measure for measuring a storage resource.

14. The system of claim 13, wherein the computing unit of measure is 128 MB of memory and one-sixteenth core CPU, and the storage unit of measure is 1.6 GB of storage space.

15. A non-transitory computer-readable storage medium storing instructions that when executed by a computer cause the computer to perform a method for allocating resources, the method comprising:
receiving a request to generate a virtual host;
assigning a server to the virtual host based on the request, with available resources on the assigned server satisfying resource requirements of the virtual host, wherein the available resources of the assigned server and the resource requirements of the virtual host are measured using a same resource unit; and
allocating resources required by the virtual host on the assigned server.

16. The non-transitory computer-readable storage medium of claim 15, wherein the request includes information indicating the resource requirements of the virtual host, and the resources required by the virtual host are measured using the resource unit.

17. The non-transitory computer-readable storage medium of claim 15, wherein the request includes information indicating a model of the virtual host.

18. The non-transitory computer-readable storage medium of claim 17, wherein assigning a server to the virtual host based on the request comprises:
determining resource requirements of the virtual host according to a predetermined corresponding relationship between a predetermined model and a respective amount of resources required, and according to the model of the virtual host, wherein the amount of resources is measured using the resource unit; and
searching for an assigned server with available resources greater than or equal to the resources required by the virtual host, wherein the available resources of the assigned server is measured using the resource unit.

19. The non-transitory computer-readable storage medium of claim 15, further comprising:
updating data indicating the available resources on the assigned server.

20. The non-transitory computer-readable storage medium of claim 15, wherein the resource unit includes a computing unit of measure for measuring a computing resource and a storage unit of measure for measuring a storage resource.
